(19) United States
(12) Patent Application Publication
(10) Pub. No.: US 2008/0000142 A1
(43) Pub. Date: Jan. 3, 2008

(54) Rattle for attracting fish

(76) Inventor: Dennis N. Pixton, Coconut Creek, FL (US)

Correspondence Address: RICHARD M. SACCOCIO, P.A., 780 W. TROPICAL WAY, PLANTATION, FL, 33317, US

(21) Appl. No.: 11/888,923

(22) Filed: Aug. 3, 2007

Related U.S. Application Data
(63) Continuation-in-part of application No. 11/105,247, filed on Apr. 13, 2005.

(51) Int. Cl. A01K 85/01

(52) U.S. Cl. 43/42.31; 43/17.1

(57) ABSTRACT

An improved rattle for attracting fish includes a hollow cylindrical chamber that is sealingly closed by ultra thin end caps. An annular, ring like member is positioned within the closed chamber so as to rest on its edge on the inner diameter of the closed chamber. The chamber diameter is larger than the outer diameter of the annular member thereby allowing the annular member to pivot on its edge when the rattle is rocked back and forth along its axial axis. The length of the chamber is relatively short. The pivoting causes the annular member to strike the sides of the closed chamber thereby producing a type of clicking sound that is known to attract fish. The combination of the ultra thin end caps and short chamber provides for improved loudness and sensitivity to slight motions of the rattle.

### CROSS REFERENCE TO RELATED APPLICATIONS

This application is related to U.S. Provisional Application Ser. No. 60/561,494, filed on Apr. 13, 2004, and is a continuation in part of application Ser. No. 11/105,247, filed Apr. 13, 2005, entitled Rattle For Attracting Fish.

### BACKGROUND OF THE INVENTION

1. Field of the Invention

This invention relates in general to the field of fishing rattles and in particular to rattle to attract fish which rattle can be used alone or in combination with a fishing lure.

2. Description of the Prior Art

Fishermen using a pole and fishing line have for many years sought ways to better their chances of catching fish. It is known that fish have a lateral line on their body that responds to sound. Accordingly, devices have been advanced in the prior art to use the sound responding lateral line to attract fish and help catch them. These prior art devices have involved myriad technologies including electronic generation of various sounds and simple beads within a tube that emit a clicking noise when shaken. The general consensus in the fishing sport and industry is that the use of sound does indeed attract fish. The prior art sound producing devices are used with hard fishing lures such as crank baits, spoons, etc. and soft fishing lure such as plastic worms , crawdads, frogs, and other artificial baits that fish are known to eat.

One prior art rattle is used with a bullet shaped weight attached to a soft plastic artificial lure as seen in U.S. Pat. No. 5,381,622. In this prior art device, a sleeve is incorporated within the body of the bullet weight. The forward and aft ends of the sleeve is provided with a cap. A cylindrical weight that is configured to slide on the sleeve. When the cylindrical member hits either the forward or aft cap, a clicking sound is generated that can be heard outside of the bullet weight. This particular rattle however requires a generous amount of movement of the weight in order to have the cylindrical member slide on the sleeve the distance needed to strike the end caps. There are disadvantages to the generous movement required to generate the clicking sound. The generous movement must for example, be intentionally caused and usually does not occur when a slight twitching of the rod occurs or when the weight's movement slightly deviates from being pulled in a straight line or when the weight encounters a rock or a weed that causes the weight to deviate from a straight line movement.

U.S. Pat. No. 5,428,919, by Enomoto, issued Jul. 4, 1995 discloses another type of a sliding annular member imbedded within a sinker that when moved either laterally or vertically, the annular member slides within a water tight air chamber striking one of the inner side walls of the sinker. Depending upon the location of the annular member within the air chamber and lateral movement of the sinker, it is possible that the annular may pivot and strike one inner wall; however, in general and under most conditions the annular will generate a noise by sliding within the air chamber rather than pivoting.

U.S. Pat. No. 3,848,353, by McClellan, issued Nov. 19, 1974, is another rattle, with an embodiment disclosing a pair of slugs (ordinary threaded nuts) within a chamber formed in a cylindrical member having a conical end. In this invention the slugs roll within the chamber causing one slug to strike one end of the chamber and the other slug strikes the other end of the chamber. In this embodiment, no provision is made to make the chamber water tight.

In prototype testing, it has been determined that the prior art rattles above noted are generally ineffective in performing their intended purpose. Either the noise produced is to too low or soft to be effectively heard outside the rattle, or the noise produced is intermittent, or the rattle is insufficiently sensitive to generate noise with slight motions of the fishing line.

Accordingly what is needed is an improvement rattle that emits a clicking sound when an artificial lure, either hard or soft, is slightly moved be it intentionally or during the normal action of the lure as it is pulled through the water or encounters a natural object in the water.

What is further needed is a rattle that is effective: that emits sufficiently loud noises; and, a rattle that produces more clicks in conjunction with slight movement of the fishing line and operates almost entirely by pivoting an internal weight.

The present invention is directed to such an improved rattle.

### SUMMARY OF THE INVENTION

The above-stated objects as well as other objects which, although not specifically stated, but are intended to be included within the scope the present invention, are accomplished by the present invention and will become apparent from the hereinafter set forth in this specification, the claims and the drawings presented herein.

The present invention, in one embodiment comprises a unique rattle that is attachable to a fishing weight, which is sometimes called a sinker, or that is used with a fishing weight, or that is used with an artificial soft or hard fishing lure. The improved and unique rattle includes a hollow cylindrical member capped on both ends with a thin membrane with an annular member located within the hollow cylindrical member. The length of the hollow member in conjunction with the outer diameter of the annular member causes the annular member to strike one side and then the other side end producing a plurality of clicking sounds with slight movement of the fishing line. The slight movement of the rattle causes the annular member to pivot within the hollow cylindrical member and strike either of the cap ends, thereby emitting the clicking sounds. In another embodiment, a small diameter sleeve extends axially within the center of the hollow cylindrical member. In this embodiment, the annular member includes an internal diameter that is sufficiently large such that the sleeve does not interfere with the pivoting action within the hollow cylindrical member.

In accordance with the above, there has been summarized the more important features of the present invention in order that the detailed description of the invention as it appears in the below detailed description of the same, may be better understood.

### BRIEF DESCRIPTION OF THE DRAWINGS

Various other objects, advantages, and features of the invention will become apparent to those skilled in the art from the following discussion taken in conjunction with the following drawing, in which:

FIG. 1 illustrates, in cross section, an embodiment of the inventive rattle;

FIG. 2 illustrates a cross section of FIG. 1 taken through the line 2-2 thereof;

FIG. 3 illustrates, in cross section, the embodiment of FIG. 1 including a sleeve axially positioned within the body of the rattle;

### DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functioning details disclosed herein are not to be interpreted as limiting, but merely as a basis for the claims and as a representative basis for teaching one skilled in the art to variously employ the present invention in virtually any appropriately detailed structure. Additionally, the verbiage used herein is intended to better enable a person to understand the invention and therefore, such verbiage is not to be interpreted as limiting the invention.

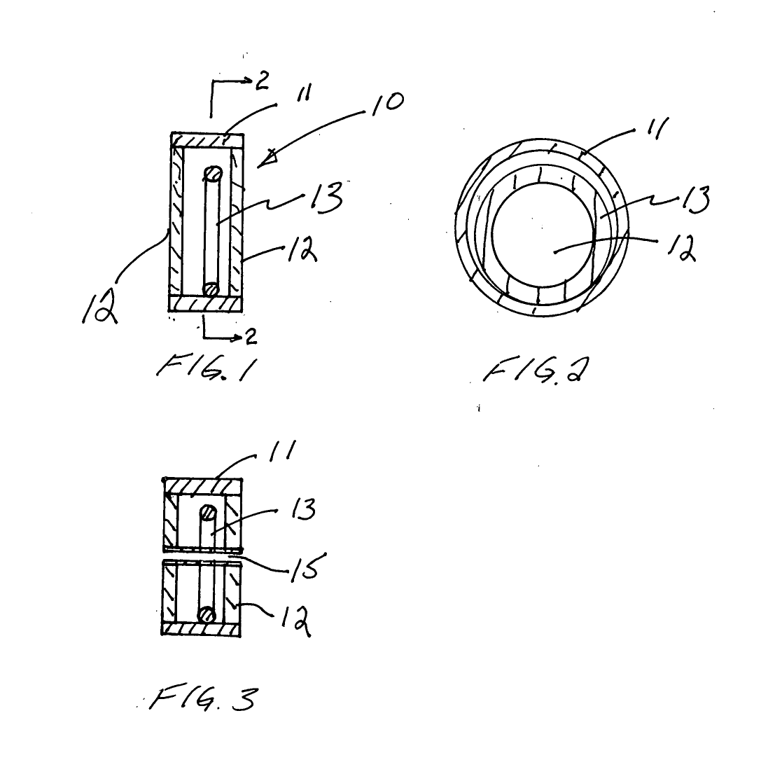

The details of the improved rattle 10 are shown in FIGS. 1 and 2. In this embodiment an annular body member 11 which comprises a hollow, substantially cylindrical member, or its equivalent, is fitted with end caps 12. An annular or ring like member 13 is located within the hollow cylindrical body 11. Annular member 13 is sized to have an outer diameter somewhat smaller that the internal diameter of the body 11 and such that when the annular member 13 rests vertically at one point against the internal diameter of body 11. In this manner, the annular member 13 is allowed to pivot at the point it rests against the internal diameter of body 11 without interfering with the internal diameter of body 11. The length of body 11 is sized such that a slight inclination of the rattle from the position shown in FIG. 1, allows the annular member 13 to pivot and strike one of the end caps 12. In practice, the internal length of body 11, between the end caps 12, can approximately be between the range of two or more times the thickness of annular member 13 but less than the external or outer diameter of the annular member 13.

In prototype testing a length of the internal length of body 11 of approximately three to four times the thickness of annular member has been shown to be satisfactory. The outer diameter of body 11 is not necessarily of any particular size; however, practical considerations of the way the rattle 10 is used either alone or in conjunction with other fishing lure apparatus, bears on the size of the outer diameter of the body 11 as it is used in practice. For example, if the inventive rattle 10 is used with a prior art bullet weight the outer diameter of the rattle 10 or the body 11 is preferably approximately equal to the outer diameter of the bullet weight. If the rattle 10 is to be used in conjunction with an artificial hard lure such as a crank bait, the outer diameter of body 11 and the overall size of the rattle 10 is dictated by the size of the crank bait. The thickness of the wall of the body is also not a factor critical to the invention or its operation; but again, practical considerations will bear on the thickness. For example, the ability to sealingly connect the side caps 12 to body 11 is a practical factor. Body 11 can be configured to integrally include one end cap 12 with the other end cap 12 being sealingly secured to body 11. Or, both end caps 12 can be sealingly secured to a hollow cylindrical configuration of body 12. The wall thickness of the hollow member 11 is to be such so that it not readily crushed by ordinary handling; but, it is not be so thick that it causes the annular member to be too small and not generate sufficient noise.

Annular or ring-like member 13 is preferably to be of the largest size possible consistent with the need to sufficiently pivot and gain sufficient velocity to result in a reasonably loud noise. For example, if the annular member thickness relative to the length of the body member 11 is above 1 to 2, the pivoting velocity will probably be too slow to generate a sufficiently loud noise. Prototype testing has determined that a ratio of annular member thickness to body length below 1:2 and above 1:4 is satisfactory where the outer diameter of the annular member is only slightly smaller than the internal diameter of the body member. The main criteria being its ability to readily pivot within the body 11 when resting on a lower oriented point of the inner diameter of the body 11 and striking one of the end caps 12.

Prototype testing has also determined that the annular member be as heavy as possible consistent however with practical concerns such as cost, and labor. This testing has further determined that an ordinary steel annular member such as a washer or a thin nut does not produce a desirably loud noise. Lead is sufficiently heavy as is tungsten.

In order to aid in the tilting or pivoting movement of the ring-like member 13, it is preferable, but not necessary that the planer cross sectional configuration of the ring-like member 13 be substantially circular as seen in FIG. 1. In this regard, any type of rounded surface that comes into contact with the inner diameter of the body member is satisfactory and preferable due to its ability to readily pivot. It is to be remembered that an object of the improved rattle is to be more sensitive to fishing line motion than the prior art. The ability to readily pivot enhances the sensitivity of the rattle. An annular member having a plurality of flats or any such equivalent configuration along its outer diameter will not have the sensitivity of an annular member having a rounded surface.

In combination with the above stated preferences, it has been determined that the wall thickness of the end caps that comprise the objects struck by the pivoting annular member is an important factor in order to result in satisfactory rattle. A relatively thin wall produces a louder sound than a relative thick wall, all other things being equal. Further, the advantages of a thin wall are markedly decreased should it be in contact with another object.

In use and operation of the inventive rattle 10, a slight inclination of the rattle from the position shown in FIG. 1 will cause the annular member 13 to pivot within the body 11 and strike one of the end caps 12 thereby producing a clicking sound. Such inclination can result from the rattle 10 being intentionally or non intentionally moved. For example if the rattle 10 is attached to an end of a fishing line that is attached to a fishing pole, a slight twitching of the fishing pole will result in intentional up and down inclination of the rattle 10 and result in a plurality of clicking noises by the annular member pivoting back and forth striking the end caps 12 each time the pivoting occurs. Or, if the line is being retrieved and the rattle 10 encounters a weed or a rock or other natural object, an unintentional up and down inclination of the rattle will occur and cause the clicking sounds. The above described construction of the inventive rattle 10 and its resulting sensitivity is thusly intended to advantageously use, both the intentional and unintentional movement of the rattle 10 to produce the clicking noises and thereby advantageously attract fish. Prototype testing has shown that due to the unique pivoting construction and operation of the rattle 10, very slight up and down inclinations will result in the producing of very audible clicking sounds of the type that has been demonstrated to attract fish.

The sensitivity of the inventive rattle 10 to produce fish attracting noises by slight movements of the rattle and the lure to which it can be attached is advantageous in murky waters as well as clear waters. While fishermen generally prefer to fish in clear water because of the belief that more fish are present in clear water, such belief is not necessarily true or at least some fish will be present in murky water. The sensitivity of the inventive rattle 10 will therefore allow fishermen to fish in murky waters as well as clear water and thereby broaden their scope of fishing and the ability to catch more fish,

FIG. 3 illustrates, in cross section, the embodiment of FIG. 1 including a sleeve 15 axially positioned within the body 11 of the rattle 10B and through the end caps 12. Sleeve 15 allows a fishing line (not shown) to pass through the rattle 10B. Sleeve 15 is sealingly attached to end caps 12. In this embodiment 10 of the inventive rattle, the inner diameter of the annular member 13 is sized so as not to interfere with the sleeve 15 or be restricted by the sleeve 15 during the pivoting motion of the annular member 13. Such sizing knowledge is within that of a person of ordinary skill in the art of the invention.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breath and scope of the drawings and description provided herein.

1. In a fish attracting rattle comprising a hollow body member sealed by end caps having an annular member positioned within the hollow body member, the improvement comprising:
the ratio of the thickness of the annular member relative to the internal length of the hollow body member being approximately between 1:2 and 1:4, and
the internal length of said hollow member being less than the outer diameter of the annular member.

2. In a fish attracting rattle comprising a hollow body member sealed by end caps having an annular member positioned within the hollow body member, the improvement comprising:
the internal length of said hollow member being less than the outer diameter of the annular member, and
the thickness of each of the end caps being between the approximate range of 0.020 inches and 0.125 inches.

3. In a fish attracting rattle comprising a hollow body member sealed by end caps having an annular member positioned within the hollow body member, the improvement comprising:
the internal length of said hollow member being less than the outer diameter of the annular member, and
each of the outer caps being only in contact with a sleeve positioned axially across said body member and through said annular member therein.
